(19) United States
(12) Patent Application Publication
(10) Pub. No.: US 2021/0272766 A1
(43) Pub. Date: Sep. 2, 2021

(54) FLUID-COOLED COMPACT X-RAY TUBE AND SYSTEM INCLUDING THE SAME

(71) Applicant: The Curators of the University of Missouri, Columbia, MO (US)

(72) Inventors: Hyoung Koo Lee, Rolla, MO (US); Ashish Avachat, V, Rolla, MO (US); Wesley William Tucker, Rolla, MO (US)

(21) Appl. No.: 17/274,674

(22) PCT Filed: Sep. 5, 2019
(86) PCT No.: PCT/US2019/049770

§ 371 Date: Mar. 9, 2021

Related U.S. Application Data
(60) Provisional application No. 62/729,150, filed on Sep. 10, 2018.

(51) Int. Cl. H01J 35/12; H01J 35/18; H01J 35/14; H05G 1/32; H05G 1/02

(52) U.S. Cl. CPC H01J 35/13; H01J 35/186; H01J 2235/1204; H05G 1/32; H05G 1/025; H01J 35/14

(57) ABSTRACT

A fluid-cooled compact x-ray system includes a compact x-ray tube and a coolant channel coupled thereto. The compact x-ray tube includes a tube housing defining a longitudinal axis, and an electron source in the tube housing and coaxial with the tube housing. The electron source is configured to generate an electron beam. The compact x-ray tube also includes an anode coaxial with the tube housing, the anode defining a plane perpendicular to the longitudinal axis and including a target material, and an electron focusing mechanism in the tube housing and configured to focus and accelerate the electron beam to the anode. The target material of the anode generates a high-energy x-ray beam as a result of bremsstrahlung interaction. The anode defines an interface between the tube housing and the coolant channel. The coolant channel includes a channel housing, and a coolant configured to dissipate heat from the anode.

### CROSS-REFERENCE TO RELATED APPLICATIONS

This application claims the benefit of priority to U.S. Provisional Patent Application No. 62/729,150, filed on Sep. 10, 2018, the entire contents and disclosure of which are hereby incorporated by reference herein.

### BACKGROUND

The embodiments described herein relate generally to X-ray imaging, and more particularly, to a fluid-cooled compact X-ray tube and X-ray systems including the same.

In the past decade, because of improved computing capabilities, there has been a significant surge in interest in developing 4D x-ray computed tomography (4D-CT) or real-time CT and applying it to various fields of research. At least some attempts to develop a 4D-CT system involve improving the temporal resolution of CT systems with a conventional CT architecture. A conventional CT architecture has two common configurations: a rotating gantry around a stationary imaging object (common in medical imaging applications), and a rotating imaging object placed in one or more stationary x-ray beams (common in industrial imaging applications).

In CT imaging, relative motion between one or more x-ray beams and an imaging object is required for acquiring a number of 2D projections of the imaging object at different angles. These projections are then fed to a CT reconstruction algorithm to reconstruct 3D images (also referred to as “slices”) and, finally, a 3D volume. The temporal resolution of a conventional CT system can be improved by increasing the speed of the relative rotation. Currently, gantry rotation time (or the time required for one complete relative rotation between the x-ray beam and an imaging object, also referred to as “rotation time”) for a typical CT system with a conventional architecture is about 300 milliseconds (msec). For quasi-real-time imaging or quasi-4D-CT systems, a temporal resolution of about 75 msec can be achieved for a 300 msec gantry rotation time using electronic triggering of data acquisition. However, for a “pure” 4D-CT system, a gantry rotation time of less than 50 msec is required. The centrifugal force acting on the rotation gantry and the components inside it reaches about 30 g when the gantry rotation time is about 300 msec in a conventional medical CT system. The current mechanical limits and materials do not allow further reduction in the gantry rotation time.

To reduce the gantry rotation time, researchers are developing semi stationary CT and stationary CT architectures that use a stationary array of distributed x-ray sources to eliminate the rotating parts in a gantry, either partially or completely, respectively. For such an array of distributed x-ray sources, to acquire enough projections for a successful CT reconstruction (200 to 400 projections, depending on the application and the reconstruction algorithm), a closely-spaced array of individually addressable x-ray sources that are capable of producing x-ray pulses at a frequency higher than a few kilohertz (kHz).

### BRIEF SUMMARY

In one aspect, a fluid-cooled compact x-ray system is provided. The x-ray system includes a compact x-ray tube and a coolant channel. The compact x-ray tube includes a tube housing extending from a first end to a second end and defining a longitudinal axis, and an electron source housed in the tube housing at the tube housing first end and coaxial with the tube housing. The electron source is configured to generate an electron beam when supplied with electric power. The compact x-ray tube also includes an anode at the tube housing second end and coaxial with the tube housing, the anode defining a plane perpendicular to the longitudinal axis and including a target material, and an electron focusing mechanism housed in the tube housing and configured to focus and accelerate the electron beam to a focal spot on the anode. The target material of the anode generates a high-energy x-ray beam as a result of bremsstrahlung interaction at the anode from the electron beam. The coolant channel is coupled to the tube housing second end, the anode defining an interface between the tube housing and the coolant channel. The coolant channel includes a channel housing, and a coolant configured to flow through the channel housing across the anode to dissipate heat from the anode.

In another aspect, a fluid-cooled compact x-ray system is provided. The x-ray system includes a coolant channel and a plurality of a compact x-ray tubes coupled in an array to the coolant channel. The coolant channel includes a channel housing, and a coolant configured to flow through the channel housing. Each of the plurality of compact x-ray tube respectively includes a compact tube housing extending from a first end to a second end coupled to the coolant channel, the tube housing defining a longitudinal axis, and an electron source housed in the tube housing at the tube housing first end and coaxial with the tube housing. The electron source is configured to generate an electron beam when supplied with electric power. Each compact x-ray tube also includes an anode at the tube housing second end and coaxial with the tube housing, the anode defining a plane perpendicular to the longitudinal axis and including a target material, the anode defining an interface between the compact X-ray tube and the coolant channel, and an electron focusing mechanism housed in the tube housing and configured to focus and accelerate the electron beam to a focal spot on the anode. The target material of the anode generates a high-energy x-ray beam as a result of bremsstrahlung interaction at the anode from the electron beam.

In yet another aspect, a compact x-ray tube is provided. The compact x-ray tube includes a housing extending from a first end to a second end and defining a longitudinal axis, and an electron source housed in the housing at the housing first end and coaxial with the housing. The electron source is configured to generate an electron beam when supplied with electric power. The compact x-ray tube also includes an anode at the housing second end and coaxial with the housing, the anode defining a plane perpendicular to the longitudinal axis and including a target material, and an electron focusing mechanism housed in the housing and configured to focus and accelerate the electron beam to a focal spot on the anode. The target material of the anode generates a high-energy x-ray beam as a result of bremsstrahlung interaction at the anode from the electron beam.

### BRIEF DESCRIPTION OF THE DRAWINGS

FIGS. 1-5 show exemplary embodiments of the systems and methods described herein.

FIG. 1 is a cross-section of an exemplary modular fluid-cooled compact x-ray system including a compact x-ray tube coupled to a coolant channel;

FIG. 2 is a cross-section of another exemplary modular compact x-ray system including a plurality of compact x-ray tubes coupled to a linear coolant channel in a single-planar array;

FIG. 3 is a cross-section of another exemplary compact x-ray system including a plurality of compact x-ray tubes coupled to a linear coolant channel in a multi-planar array;

FIG. 4 is a cross-section of another exemplary compact x-ray system including a plurality of compact x-ray tubes coupled to a curved, closed-loop coolant channel in a single-planar array; and

FIG. 5 is a cross-section of another exemplary compact x-ray system including a plurality of compact x-ray tubes coupled to a curved, closed-loop coolant channel in a multi-planar array.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations are combined and interchanged, such ranges are identified and include all the sub-ranges contained therein unless context or language indicates otherwise.

In contrast to the conventional computed tomography (CT) systems having a rotation gantry described above, in a CT system built with a stationary CT architecture, relative motion between an x-ray beam and an imaging object is carried out by electronically triggering x-ray sources in a stationary array to sweep an x-ray beam circumferentially for scanning the imaging object. Because there is no physical rotation, and the x-ray beam is swept electronically, the rotation time (i.e., the time it takes to sweep the beam across the imaging object) can be reduced to 50 msec or less. With such a short rotation time, the imaging time for each projection is drastically decreased. For example, in a CT system that acquires 400 projections in one complete rotation (covering 360 degrees of projections) that takes 50 msec, the imaging time for each projection is 0.125 msec.

The decreased imaging time, or the x-ray exposure per projection, requires a significantly higher number of photons to be reached at a detector to maintain the image quality of each projection with a suitable signal-to-noise ratio. The number of photons generated at the x-ray source is controlled based on the electric power (e.g., current) supplied thereto. In order to generate the bremsstrahlung x-rays that are suitable for CT imaging, an electron beam of desired energy and current is accelerated to a target, where the electrons are slowed to generate the bremsstrahlung x-rays. Generating these bremsstrahlung x-rays by electron impact is a highly inefficient process. Only about 1% of the incident electron energy yields resultant x-ray energy. The rest of the incident electron energy (i.e., about 99%) is converted to heat. That is, a substantial amount of heat is generated in the target. Therefore, the temperatures at the area of the target where the x-rays are generated (e.g., a focal spot) increase drastically as the electron beam current is increased.

Dissipation of this heat is important in the design of x-ray sources potentially to be used for stationary 4D-CT. Moreover, as the size of the x-ray sources is reduced, and, therefore, the size of the anode is decreased, the need for effective heat dissipation increases.

The subject matter described herein provides a solution to this issue of heat dissipation, particularly in the context of compact x-ray sources. Specifically, the embodiments herein provide a modular fluid-cooled compact x-ray tube and systems including one or more such compact x-ray tubes coupled to a coolant channel. These embodiments can be implemented for, but are not limited to, a stationary array of distributed x-ray sources for a number of x-ray imaging modalities where a high temporal resolution is a requirement (e.g., x-ray CT with conventional architecture, x-ray CT with semi-stationary architecture, x-ray fluoroscopy, x-ray tomosynthesis, and/or x-ray imaging based on flat-panel x-ray sources).

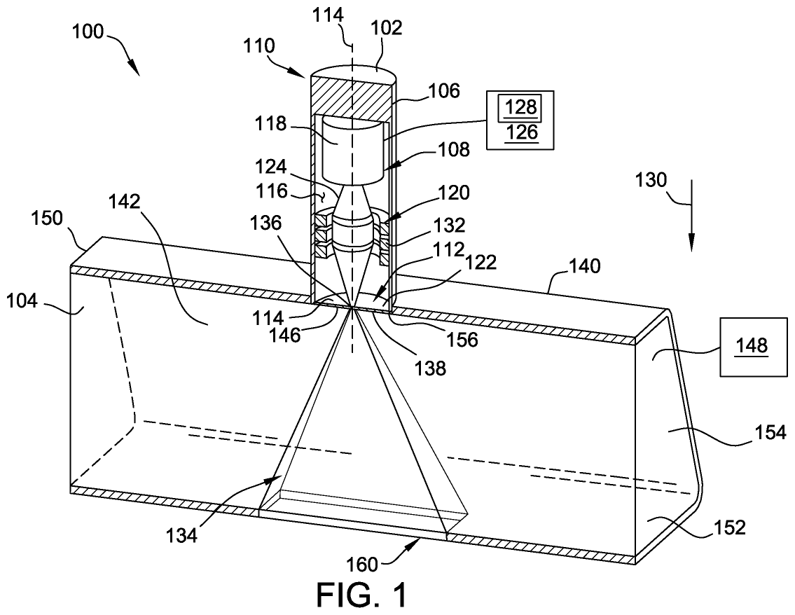

FIG. 1 is a cross-section of an exemplary modular fluid-cooled compact x-ray system 100 including a compact x-ray tube 102 coupled to a coolant channel 104. The compact x-ray tube 102 is configured to generate high-energy and high-current x-ray pulses at a high frequency suitable for stationary CT imaging. The coolant channel 104 coupled to the compact x-ray tube 102 is configured to transfer or dissipate heat from the compact x-ray tube 102 (e.g., from an anode thereof, as described further herein) that is generated as the compact x-ray tube 102 generates the high-energy x-rays (e.g., at a focal spot of the anode).

As used herein, “compact” is used generally to refer to the size of the compact x-ray tube 102, which is smaller than the conventional x-ray tubes described above. For instance, in the exemplary embodiment, the compact x-ray tube 102 of the present disclosure has a diameter between about 1 cm and about 10 centimeters (cm), whereas conventional x-ray tubes have a diameter of at least 15 cm. In some embodiments, the compact x-ray tube 102 of the present disclosure has a diameter of up to about 5 cm, or up to about 3 cm, or up to about 2 cm, or up to about 1 cm. In at least some embodiments, the compact x-ray tube 102 of the present disclosure has a diameter of between about 1 cm and about 2 cm.

The compact x-ray tube 102 includes a housing 106 (also referred to as a “tube housing”) that houses x-ray generation components 108 thereof. The housing 106 extends from a first end 110, which may also be referred to as a first end of the compact x-ray tube 102, to a second end 112, which may also be referred as a second end of the compact x-ray tube 102. Likewise, the diameter of the compact x-ray tube 102 may accordingly also refer to a diameter of the housing 106. A longitudinal axis 114 of the compact x-ray tube 102 extends from the first end 110 of the housing 106 to the second end 112 of the housing 106. The housing 106 includes any suitable housing material such as metal and/or a polymeric material. In the exemplary embodiment, an interior 116 of the housing 106 in which the x-ray generation components 108 are located is maintained under a vacuum. Although not shown, a vacuum pump or other component configured to induce or maintain the vacuum in the housing 106 may be operably coupled to the housing 106. The vacuum pressure in the housing 106 is within a range from about 1E-3 Torr to about 1E-8 Torr.

The x-ray generation components 108 include an electron source 118, an electron focusing mechanism 120, and an anode 122. The electron source 118 is positioned at the first end 110 of the housing 106 and, in the exemplary embodiment, is coaxial with the housing 106 (e.g., shares the same longitudinal axis 114). The electron source 118 emits electrons in the form of an electron beam 124 that is directed toward the second end 112 of the housing 106 (i.e., toward the electron focusing mechanism 120 and the anode 122). The vacuum in the housing 106 facilitates ensuring that the flow of electrons in the electron beam 124 is unrestricted while flowing from the electron source 118 (the cathode) to the anode 122 (i.e., towards the second end 112 of the housing 106). The electron source 118 may include one or more filaments (hot cathodes), one or more field emitters (cold cathodes, such as carbon nanotubes (CNT)), and/or any other suitable electron source or combination thereof. The electron source 118 may employ thermionic emission, field emission, photo emission, ferroelectric emission, laser diode based emission, monolithic semiconductor based emission, or any other mechanisms of electron emission to generate and emit the electron beam. In the exemplary embodiment, the electron source 118 emits the electron beam 124 in response to electric power supplied thereto. Generally, the energy, current, and/or other characteristics of the electron beam 124 depend on the power supplied to the electron source 118. Increased electric power supplied to the electron source 118 increases the number and energy of the electrons emitted therefrom in the electron beam 124. Constant electric power (e.g., current) supplied to the electron source 118 results in a constant electron beam, whereas pulsed power (e.g., current) supplied to the electron source 118 results in a pulsed electron beam. Whether the electron beam 124 is a constant beam or a pulsed beam depends on the particular system in which the compact x-ray tube 102 is implemented.

In the exemplary embodiment, a controller 126 is communicatively coupled to the compact x-ray tube 102, and, more specifically, to the electron source 118. The controller 126 is configured to control the electric power supplied to the electron source 118. The controller 126 includes a user interface 128 such that a user or operator of the x-ray system 100 can provide specific inputs regarding the desired control of the compact x-ray tube 102, such as the timing, magnitude, and characteristics of the electron beam 124 current from the electron source 118.

In the exemplary embodiment, the controller 126 is implemented by a processor communicatively coupled to a memory device for executing instructions (neither shown) based on the input from the operator. In some embodiments, executable instructions are stored in the memory device. Alternatively, the controller 126 may be implemented using any circuitry that enables the controller 126 to function as described herein.

In the exemplary embodiment, the controller 126 performs one or more operations described herein by programming the processor. For example, the processor may be programmed by encoding an operation as one or more executable instructions and by providing the executable instructions in the memory device. The processor may include one or more processing units (e.g., in a multi-core configuration). Further, the processor may be implemented using one or more heterogeneous processor systems in which a main processor is present with secondary processors on a single chip. As another illustrative example, the processor may be a symmetric multi-processor system containing multiple processors of the same type. Further, the processor may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), and any other circuit capable of executing the functions described herein.

In the exemplary embodiment, the memory device is one or more devices that enable information such as executable instructions and/or other data to be stored and retrieved. The memory device may include one or more computer readable media, such as, without limitation, dynamic random access memory (DRAM), static random access memory (SRAM), a solid state disk, and/or a hard disk. The memory device may be configured to store, without limitation, application source code, application object code, source code portions of interest, object code portions of interest, configuration data, execution events and/or any other type of data.

The electron focusing mechanism 120 is located downstream of the electron source 118 within the housing 106. “Downstream” refers generally to a direction oriented from the first end 110 of the housing 106 to the second end 112 of the housing 106, as indicated by arrow 130. The electron focusing mechanism 120 focuses the electron beam 124 to a desired focal spot size. The energy of the electron beam 124 at the anode 122 determines the energy spectrum of the x-rays generated at the anode 122. In the exemplary embodiment, the electron focusing mechanism 120 is annular and coaxial with the housing 106.

In some embodiments, the electron focusing mechanism 120 includes one or more electrostatic or electromagnetic lenses 132, such as electrostatic aperture-type lenses and/or Einzel lenses. In “single lens” embodiments, one lens electrode of the electrostatic aperture lens type is used. In “double lens” embodiments, two axicentered or coaxial lens electrodes of the electrostatic aperture lens type are used. Einzel lenses are a variant of an electrostatic immersion-type lens and may include three equidistant electrodes. The number and characteristics of the one or more lenses 132 determines how the electron beam 124 is focused to an ultimate focal spot size (i.e., the ultimate size of the electron beam 124 when it reaches the anode 122). In at least some embodiments, the ultimate focal spot size is 1 mm or less.

For example, the lens aperture, thickness, location (e.g., a cathode-to-lens distance), and potential may affect how the electron beam 124 is focused. The lens aperture may vary from about 6 mm to about 16 mm. The lens thickness may vary from about 1 mm to about 3 mm. Generally, a focal length of the lens increases as the lens aperture increases, but decreases as the lens thickness increases. The cathode-to-lens distance may vary from about 12 mm to about 32 mm. Generally, as the cathode-to-lens distance increases, the focal spot size decreases, for lower cathode-to-lens distance. The focal spot size may increase with cathode-to-lens distance increases, for greater cathode-to-lens distances. This “V-shaped” relationship is observed because the focal length of the lens is inversely proportional to the cathode-to-lens distance. The lens potential may vary from about 3 kV (e.g., for lower anode voltages) to about 30 kV (e.g., for higher anode voltages). Generally, an increase in the lens potential leads to an increase in the focal length of the lens, and the focal spot size of the electron beam 124 is directly proportional to the difference between the focal length and an anode-to-lens distance. Therefore, as the focal length increases from a value smaller than the anode-to-lens distance, the focal spot size decreases; the ultimate focal spot size is smallest when the focal length is equal to the anode-to-lens distance.

The anode 122 is located at the second end 112 of the housing 106 and performs several functions. In particular, in the exemplary embodiment, the anode 122 at least partially defines the second end 112 of the housing 106 and also defines a threshold or interface between the compact x-ray tube 102 and the coolant channel 104. Moreover, the target material that is deposited on or attached to the anode 122 (described further herein) generates an x-ray beam 134 used to image an imaging object (not shown).

The anode 122 includes a target material suitable to generate a desired amount of high-energy x-rays. That is, the energy of x-rays produced at the anode 122 is a function of electron energy of the electron beam 124, which itself is a function of the potential difference between the anode 122 and the cathode (i.e., the electron source 118). The frequency of the generated x-ray pulses is function of the frequency at which the electron source 118 is operated (e.g., turned on and off). The target material of the anode 122 affects how much x-ray energy is produced. In operation, the target material slows down the electrons of the electron beam 124 to generate bremsstrahlung x-rays of the x-ray beam 134. The x-rays are generated isotopically at a focal spot 136 of the anode 122 where the electron beam 124 hits the anode 122. The energy and quantity of the x-rays depends on the characteristics of the electron beam 124 that reaches the focal spot 136, and the characteristics of the target material. For example, a pulsed electron beam 124 results in a pulsed x-ray beam 134, and a constant electron beam 124 results in a constant x-ray beam 134.

Suitable target materials include high-atomic number elements, such as tungsten, to improve the yield of x-ray generation of the anode 122. The anode 122 may include a substrate 138 with the target material deposited thereon or may be fully comprised of the target material. The substrate 138 provides structural integrity to the anode 122 to withstand the pressure difference between the housing 106 and the coolant channel 104. The substrate 138 also facilitates conducting heat from the focal spot 136 on the anode 122 to a larger surface area (i.e., the surface area of the anode 122). The substrate 138, in some embodiments, also acts as an x-ray filter to facilitate ensuring that the low-energy photons are filtered out. In the exemplary embodiment, the x-ray beam 134 includes x-rays having an energy of about 30 kilovolts (kV). In some embodiments, the x-rays have an energy of about 100 kV to about 140 kV (e.g., suitable for chest CT imaging).

In the exemplary embodiment, the anode 122 is a transmission-type anode, as opposed to a reflection-type anode as in a conventional x-ray source. Put another way, the anode 122 is coaxial with the housing 106 and defines a plane generally perpendicular to the longitudinal axis 114 of the housing 106. In one exemplary embodiment, the focal spot 136 is defined at the location where the longitudinal axis 114 intersects this plane. The x-ray beam 134 is generated isotopically.

Specifically, the x-ray beam 134 is emitted through the coolant channel 104 and toward an imaging object (not shown). The coolant channel 104 includes a housing 140 (also referred to as a “channel housing”) that encloses a coolant fluid 142. In the exemplary embodiment, the coolant fluid 142 flows across the anode 122 to dissipate heat from the anode 122, resulting in a cooled anode 122 and the prevention of thermal damage to or melting of the anode 122 during the generation of x-rays. In particular, heat is generated at the focal spot 136 at the anode 122, or at a first surface 144 of the anode 122, and is distributed, by the substrate 138, across the first surface 144 of the anode 122 and through the anode 122 to a second, opposing surface 146 thereof. The coolant fluid 142 flows across the second surface 146 of the anode 122 to dissipate the heat therefrom.

In one exemplary embodiment, the channel housing 140 includes a material configured to act as a heat sink for the heat transferred to the coolant fluid 142. For example, the channel housing 140 may include aluminum, copper, stainless steel, or any other suitable structural metal. In some embodiments, the coolant channel 104 also includes an additional or alternative radiant feature (e.g., a coil, not shown) to dissipate heat from the coolant fluid 142.

In some embodiments, the coolant fluid 142 flows through the channel housing 140 under a naturally occurring convective flow. In other embodiments, the coolant channel 104 includes a pump 148 configured to actively pump the coolant fluid 142 through the channel housing 140 to induce forced convection. The coolant fluid 142 includes a light-element fluid that does not substantially attenuate the x-ray beam 134 as the x-ray beam 134 travels therethrough. The coolant fluid 142 may include helium, water, liquid nitrogen, or any other suitable coolant fluid or combination thereof. In the exemplary embodiment, the coolant fluid 142 is kept at a temperature well below the melting point of the anode target material and/or the substrate 138 to ensure heat transfer of heat from the anode 122 to the coolant fluid 142. In some embodiments, the majority of the coolant fluid 142 is kept below about 100° C., such that coolant fluid 142 local to or directly adjacent the anode 122 is kept well below the melting point of the anode material.

In the exemplary embodiment, the channel housing 140 includes a first wall 150 adjacent to the second end 112 of the tube housing 106 and an opposing second wall 152. The first wall 150 and the second wall 152 may directly adjoin one another (e.g., for a cylindrical or otherwise curved channel housing 140) or may be coupled to one another via one or more side walls 154 (e.g., for a rectangular prismatic or other such channel housing 140). In the exemplary embodiment, the first wall 150 includes a tube mounting recess 156 defined therein. The anode 122 is disposed within the mounting recess 156 and at least partially defines the interface between the compact x-ray tube 102 and coolant channel 104 at the mounting recess 156. In some embodiments, a portion of the tube housing 106 (e.g., ends of a side wall of the housing 106) is also disposed in the mounting recess 156. As such, in some embodiments, the coolant channel 104 is configured as a base or jig to hold the compact x-ray tube 102.

The second wall 152 includes an x-ray window 160 therein generally opposite the mounting recess 156, or opposite the anode 122. The x-ray window 160 permits transmission of x-rays through the coolant channel 104 without attenuation. The x-ray window 160 is transparent to the x-rays, or may function as an x-ray filter to only permit transmission of x-rays of a desired energy therethrough. The x-ray window 160 may include glass, a polymeric material, a filtering materials (e.g., aluminum, copper, beryllium), and/or other suitable materials or combinations thereof. The x-ray window is configured to shape the cross-section of the x-ray beam 134 to a desired shape and may be the first in a series of collimators (not shown) for shaping the x-ray beam 134.

In the exemplary embodiment of FIG. 1, the coolant channel 104 is depicted as a linear coolant channel. As described further herein, the coolant channel 104 may have any desired shape, size (e.g., width, depth, length, etc.), or configuration to suit the particular implementation of the x-ray system 100. The compactness of the compact x-ray tube 102 and the ability to customize the design of the coolant channel 104 makes the present technology “modular.” “Modular” refers generally to this flexibility in the design of the x-ray system 100, which, as described further herein, may include a plurality of compact x-ray tubes 102 in any desired configuration. The present disclosure provides the fluid-cooled compact x-ray tube 102 that can be used as a stand-alone x-ray source, such as that shown in FIG. 1, or, based on the modular nature of the compact x-ray tube 102 and coolant channel 104, to design an array of multiple x-ray sources that is linear or circular, single-planar or multi-planar, and open-looped or closed-looped for a number of x-ray imaging modalities.

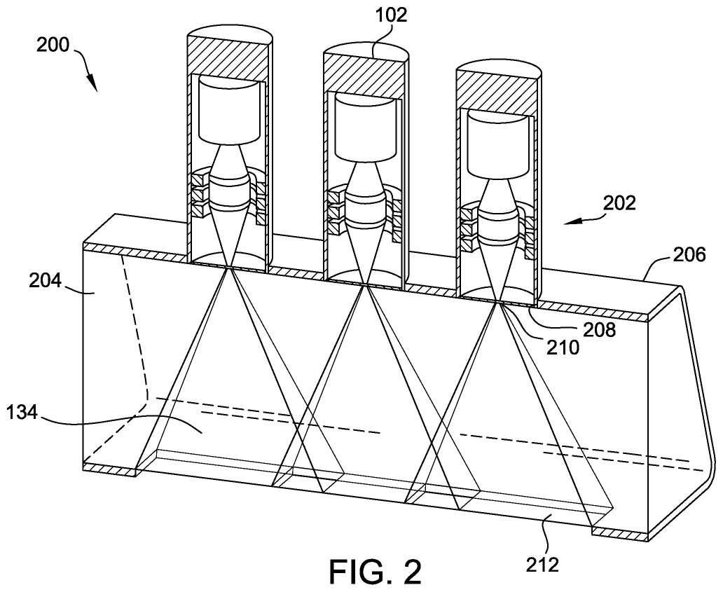

FIG. 2, for example, depicts another modular fluid-cooled compact x-ray system 200 including a linear, single planar array 202 of compact x-ray tubes 102 coupled to a linear coolant channel 204. In the exemplary embodiment, the x-ray system 200 includes three compact x-ray tubes 102. A housing 206 of the coolant channel 204 includes three corresponding mounting recesses 208 at which the three compact x-ray tubes 102 are mounted. The housing 206 further includes a single x-ray window 212 opposite the compact x-ray tubes 102, such that the x-ray beams 134 generated thereby (which overlap partially in the exemplary embodiment) are all transmitted through the same x-ray window 212. In other words, a single x-ray window 212 may transmit more than one x-ray beam 134. In an alternative embodiment, in which the x-ray beams 134 of the compact x-ray tubes 102 do not overlap, individual x-ray windows are provided in the housing 206, corresponding to each of the compact x-ray tubes 102, to transmit the x-ray beams 134 therethrough individually.

The configuration illustrated in FIG. 2 and similar configurations of a single array or combinations of such linear arrays may be used for designing a number of x-ray imaging systems of various x-ray imaging modalities, such as, but not limited to, an x-ray tomosynthesis system or an x-ray CT system with a gantry of a polygonal shape. In the exemplary embodiment, all of the compact x-ray tubes 102 in an array are controllable by the same controller, such as the controller 126 (shown in FIG. 1). The controller 126 may control the electric power (e.g., current) supplied to every compact x-ray tube 102 collectively. In other words, the compact x-ray tubes 102 may be electrically coupled such that the same power is delivered to all of compact x-ray tubes 102, and each compact x-ray tube 102 is activated with same power signal as the adjacent compact x-ray tube(s) 102. The controller 126 may additionally or alternatively supply electric power to the compact x-ray tubes 102 individually (either sequentially or simultaneously, for example, via individual power sources).

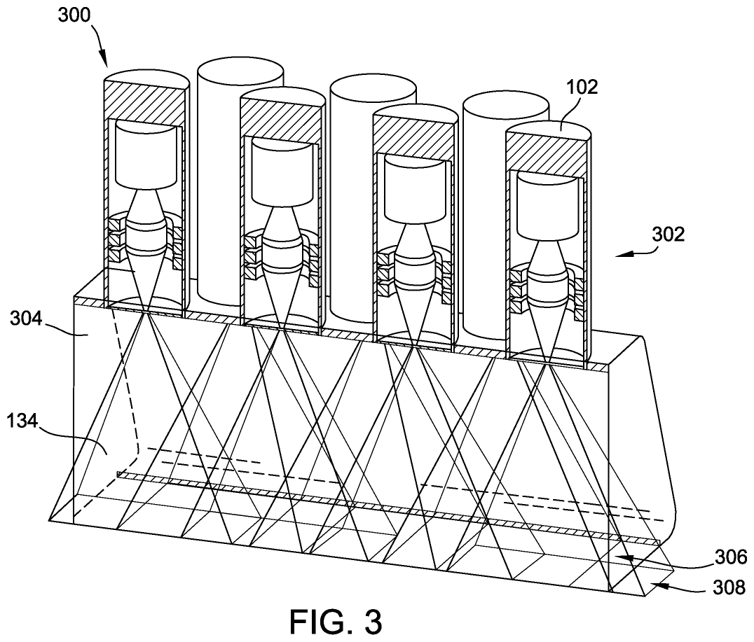

FIG. 3 depicts another modular fluid-cooled compact x-ray system 300 including a linear, multi-planar array 302 of compact x-ray tubes 102 coupled to a linear coolant channel 304. In the exemplary embodiment, the compact x-ray tubes 102 are staggered or offset such that the x-ray beams 134 define two overlapping beam planes 306, 308. Such an overlapping or staggered arrangement of the compact x-ray tubes 102 accommodates a greater number of compact x-ray tubes 102 than a single row of compact x-ray tubes 102.

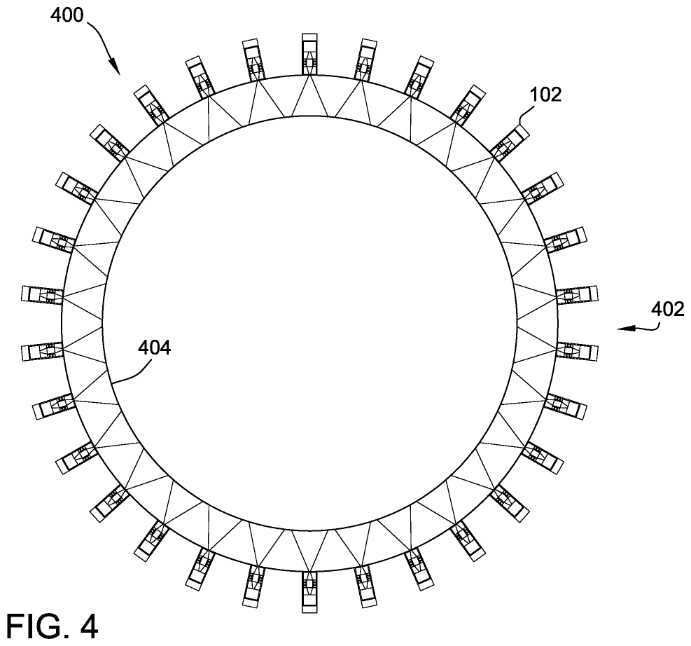

FIG. 4 depicts another modular fluid-cooled compact x-ray system 400 including a single-planar array 402 of compact x-ray tubes 102 coupled to a curved, closed-loop coolant channel 404. In the exemplary embodiment, the x-ray system 400 includes thirty compact x-ray tubes 102 arranged circumferentially about the coolant channel 404. Any number of compact x-ray tubes 102 may be arranged about the coolant channel 404 without departing from the scope of the present disclosure. Notably, if the x-ray system 400 is closed-looped, the coolant channel 404 may facilitate the coolant fluid (e.g., coolant fluid 142, shown in FIG. 1) to ingress and egress through additional channel elements (not shown) that are tangentially attached to the (primary) coolant channel 404. It should be readily understood that x-ray systems of varying shapes, sizes (e.g., diameters), and/or orientations may be constructed from a plurality of the compact x-ray tubes 102 described herein.

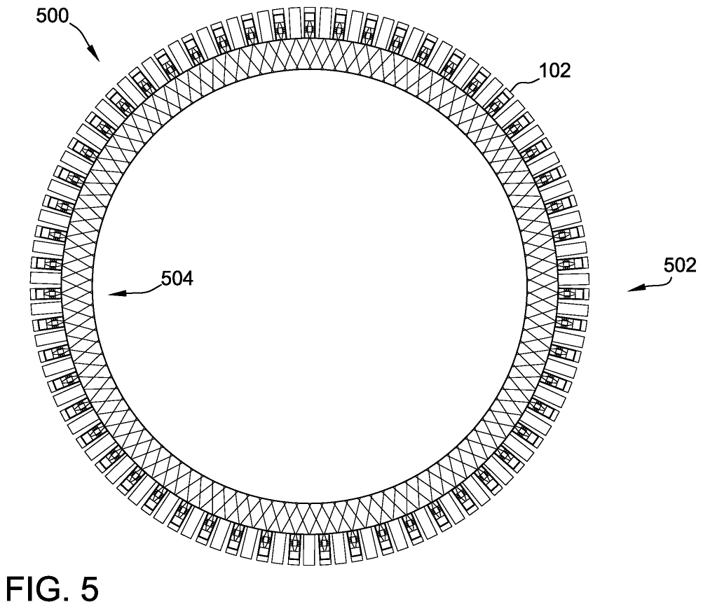

FIG. 5 depicts another modular fluid-cooled compact x-ray system 500 including a multi-planar array 502 of compact x-ray tubes 102 coupled to a curved, closed-loop coolant channel 504. In the exemplary embodiment, the x-ray system 500 includes 90 compact x-ray tubes 102 arranged circumferentially about the coolant channel 504 in an “out-of-phase” or staggered configuration, similar to that shown in FIG. 3. In some embodiments, more than 100 compact x-ray tubes 102 are arranged in a circular, multi-planar array, such as 180 or 200 compact x-ray tubes 102, to facilitate the desired number of images that can be captured using such a system.

The circular arrays 402, 502 of modular fluid-cooled compact x-ray tubes, as shown in FIGS. 4 and 5, can be used for a stationary multi-source array for a 4D-CT system with a stationary architecture. These arrays 402,502 can also be used for imaging systems with other x-ray imaging modalities where a circular array of multiple x-ray sources is required.

The present disclosure provides modular fluid-cooled compact x-ray tube technology. This technology facilitates: 1) designing a two-dimensional (2D) or three-dimensional (3D) imaging system with a single compact x-ray tube as an independent x-ray source; and 2) designing a 2D, 3D, or 4D imaging system with multiple compact x-ray tubes as a multi-source array of individually controllable x-ray sources. Each “module” of the x-ray systems described herein includes the following elements: an electron source, an electron focusing mechanism, an anode, a vacuum envelope, a fluid coolant, and a coolant channel. The electron source housed inside a housing under vacuum produces a constant or a pulsed electron beam that is focused using the electron focusing mechanism to a desired focal spot on the anode. The anode, as an interface between the housing under vacuum and coolant fluid in the coolant channel, is made of or deposited with a target material that generates a constant or a pulsed beam of bremsstrahlung x-rays. The coolant fluid flows inside the coolant channel to cool the focal spot by removing the heat from the anode, either with a natural convection or with a forced convection. Coupling the cooling channel to the compact x-ray tube enables the compact x-ray tube to be compact (i.e., have a smaller anode and a smaller overall diameter). The customizable fluid channel and the compactness of the x-ray tube make a typical embodiment of this technology suitable for various x-ray imaging modalities with architectures that use stationary arrays of multiple x-ray sources. Such an embodiment of the disclosed technology can be used to design a multi-source array that is linear or circular, single-planar or multi-planar, and open-looped or closed-looped; this array can be applied in designing x-ray imaging modalities such as, but not limited to, x-ray CT or x-ray tomosynthesis.

Exemplary embodiments of methods and systems are described above in detail. The methods and systems are not limited to the specific embodiments described herein, but rather, components of systems and/or steps of the methods may be used independently and separately from other components and/or steps described herein. Accordingly, the exemplary embodiment can be implemented and used in connection with many other applications not specifically described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose various embodiments, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A fluid-cooled compact x-ray system comprising:
a compact x-ray tube comprising:
a tube housing extending from a first end to a second end and defining a longitudinal axis;
an electron source housed in said tube housing at said tube housing first end and coaxial with said tube housing, said electron source configured to generate an electron beam when supplied with electric power;
an anode at said tube housing second end and coaxial with said tube housing, said anode defining a plane perpendicular to the longitudinal axis and comprising a target material; and
an electron focusing mechanism housed in said tube housing and configured to focus and accelerate the electron beam to a focal spot on said anode, wherein said target material of said anode generates a high-energy x-ray beam as a result of bremsstrahlung interaction at said anode from the electron beam; and
a coolant channel coupled to said tube housing second end, wherein said anode defines an interface between said tube housing and said coolant channel, said coolant channel comprising:
a channel housing; and
a coolant configured to flow through said channel housing across said anode to dissipate heat from said anode.

2. The fluid-cooled compact x-ray system of claim 1, wherein said channel housing comprises a first wall coupled to said tube housing second end and an opposing second wall.

3. The fluid-cooled compact x-ray system of claim 2, wherein said coolant channel further comprises an x-ray window defined in said second wall opposite said anode, wherein said x-ray window is configured to transmit at least a portion of the high-energy x-ray beam therethrough.

4. The fluid-cooled compact x-ray system of claim 2, wherein said coolant channel further comprises an aperture defined in said first wall and configured to shape the high-energy x-ray beam.

5. The fluid-cooled compact x-ray system of claim 1, wherein said coolant comprises one of Helium and water.

6. The fluid-cooled compact x-ray system of claim 1, wherein said coolant channel further comprises a pump configured to pump said coolant through said channel housing.

7. A fluid-cooled compact x-ray system comprising:
a coolant channel comprising:
a channel housing; and
a coolant configured to flow through said channel housing; and
a plurality of compact x-ray tubes coupled in an array to said coolant channel, wherein each of said plurality of compact x-ray tubes respectively comprises:
a compact tube housing extending from a first end to a second end coupled to said coolant channel, said tube housing defining a longitudinal axis;
an electron source housed in said tube housing at said tube housing first end and coaxial with said tube housing, said electron source configured to generate an electron beam when supplied with electric power;
an anode at said tube housing second end and coaxial with said tube housing, said anode defining a plane perpendicular to the longitudinal axis, said anode defining an interface between said compact X-ray tube and said coolant channel and comprising a target material; and
an electron focusing mechanism housed in said tube housing and configured to focus and accelerate the electron beam to a focal spot on said anode, wherein said target material of said anode generates a high-energy x-ray beam as a result of bremsstrahlung interaction at the anode from the electron beam.

8. The fluid-cooled compact x-ray system of claim 7, wherein said array is a single-planar array.

9. The fluid-cooled compact x-ray system of claim 7, wherein said array is a multi-planar array.

10. The fluid-cooled compact x-ray system of claim 7, wherein said coolant channel forms a closed loop.

11. A compact x-ray tube comprising:
a housing extending from a first end to a second end and defining a longitudinal axis;
an electron source housed in said housing at said housing first end and coaxial with said housing, said electron source configured to generate an electron beam when supplied with electric power;
an anode at said housing second end and coaxial with said housing, said anode defining a plane perpendicular to the longitudinal axis and comprising a target material; and
an electron focusing mechanism housed in said housing and configured to focus and accelerate the electron beam to a focal spot on said anode, wherein said target material of said anode generates a high-energy x-ray beam as a result of bremsstrahlung interaction at said anode from the electron beam.

12. The compact x-ray tube of claim 11, wherein said housing has a diameter of up to 5 cm.

13. The compact x-ray tube of claim 11, wherein said electron focusing mechanism comprises one or more Einzel lenses.

14. (canceled)

15. (canceled)

16. The compact x-ray tube of claim 11 further comprising a controller communicatively coupled to said electron source and configured to control the electric power supplied to said electron source, wherein the electric power supplied to said electron source is one of a constant current and a pulsed current.

17. The compact x-ray tube of claim 11, wherein said housing defines a vacuum envelope.

18. The compact x-ray tube of claim 11, wherein said anode further comprises a substrate on which said target material is deposited.

19. (canceled)

20. The compact x-ray tube of claim 11, wherein said target material comprises Tungsten.

21. The compact x-ray tube of claim 11, wherein said anode defines at least a portion of said housing second end.

22. The compact x-ray tube of claim 11, wherein said electron source comprises one of a filament and a carbon nanotube (CNT).

23. The compact x-ray tube of claim 11, wherein the high-energy x-ray beam has an energy greater than 50 kV.
